(19) United States
(12) Patent Application Publication
(10) Pub. No.: US 2013/0158846 A1
(43) Pub. Date: Jun. 20, 2013

(54) INTELLIGENT URBAN PUBLIC TRANSPORTATION SYSTEM ORIENTED TO PASSENGER TRAVEL AND IMPLEMENTATION METHOD THEREOF

(71) Applicant: Yukang Zhang, Guangzhou (CN)

(72) Inventor: Yukang Zhang, Guangzhou (CN)

(21) Appl. No.: 13/819,040

(22) PCT Filed: Aug. 8, 2011
(86) PCT No.: PCT/CN2011/078101

§ 371 Date: Feb. 26, 2013

(30) Foreign Application Priority Data
Aug. 26, 2010 (CN) 201010265284.9

(51) Int. Cl. G08G 1/127

(52) U.S. Cl. CPC G08G 1/127
USPC 701/117

(57) ABSTRACT

A passenger behavior-oriented smart urban public transport system and its implementation, which includes a field system mounted on a vehicle and a control center controlling the field system. The field system is connected to the control center via a wireless connection means. The control center is for receiving trip instructions from a passenger, generating a bus running route and sending said route to the field system mounted on the bus. The bus will then travel along the route received from the control center. The control center will also send the information of the route to the passenger while the bus is on its way. This invention provides an entirely new type of urban public transport automatic management system, which centers around the response to passenger travel demands, providing bus service at suitable places for passengers to get on and get off through the control center's intelligent scheduling and dispatching of the vehicles in the system. The present invention also discloses a method of implementing such system.

### FIELD OF THE INVENTION

The present invention relates to an urban public transport system, and specifically refers to a passenger behavior-oriented smart urban public transport system. The present invention also relates to the implementation of the system.

### BACKGROUND OF THE INVENTION

Presently, the city's public transport system for urban operations is typically dominated by buses and subways running on fixed lines (hereinafter referred to as public transport) and taxies running un-fixed routes. The design of the system does not consider how to obtain the actual real-time demand to dynamically adjust the transporting capacity for most of its lines. In cities with an advanced public transportation system, the static transit routes are designed with assistance from transit planning software. Such transit planning software is based on a passenger traffic flow forecast model and the urban traffic flow characteristics of the given city. It can, to a certain degree, provide the basis for designing urban public transport network and line arrangements, especially for cities with a stable population and infrastructure. However, for cities with a significant mobile population and/or rapid changes of urban infrastructure, it has difficulties to provide assistance in accurate planning and forecasting for the transit system. For instance, most large and middle sized cities in China are in the stage of urbanization, with rapid development of public infrastructure and increased mobility of the population, and the existing transit planning software cannot provide good results in actual applications. As a result, no matter how much efforts are made to adjust the arrangement of bus lines, the system cannot keep up with the changes in the passenger demand.

Thus, in order to better serve the passengers, transit operators have actually introduced some intelligent transportation systems. The basic operating mode of such existing intelligent transportation systems used in China is: positioning the vehicles through a GPS device carried thereon and dynamically displaying and monitoring the vehicles on a large monitor in the control center. The control center can then conduct, mainly manually by its staff, appropriate vehicle scheduling, and provide forecast of the vehicle arrival information to passengers waiting in the stations. In addition, the vehicle en route can, via GPS positioning performed by the GPS device carried thereon, prompt its passengers right before arriving at the next station, and can communicate with the control center. This system has matured and been used in large-sized cities in China. By using such intelligent transport system, the control center can control the interval at which the vehicles are dispatched and the passengers can more accurately know the arrival time of the vehicle. This intelligent transport system, however, is still just an improvement made on the basis of the static arrangement of bus lines and can not fundamentally overcome the defects mentioned above. It cannot solve the problems of the delayed response to dynamic changes of passenger demands, and line capacities are not adjusted in a scientific way. The control center's scheduling instructions usually only work to coordinate vehicles on the same line, not those on different lines in the system, and therefore cannot achieve the system-wide overall coordination in scheduling vehicles. From the system point of view, such transit system still cannot rapidly respond to the changes in passenger flows, and still cannot have the instant information as the basis to rearrange lines. From the passenger point of view, with such transit system, they still have to passively adapt to the existing line arrangements and, if there is no suitable line and stop near their destination, they need to interchange. This is not sufficiently personalized. Therefore, the conventional public transport planning software and intelligent transportation system cannot provide quality services for passengers in large and middle sized cities.

Another major urban public transport tool is the taxi. Taxi's route is completely dynamic, with high adaptability, but a large number of taxies has to invested in a city to achieve a good result. Furthermore, even for taxies, their number and routes can not always change with the changes of passenger traffics in any given regions. For instance, during rush hours, passengers are often difficult to find a taxi, while the taxi no-load rate can reach a certain level during non-rush hours. In order to improve the operational efficiency, taxi companies are generally building a taxi system for monitoring and management, and to provide the community with a taxi-on-demand service. Through GPS, the taxi's location can be dynamically displayed on a large screen in the control center. Based on the passenger location and locations of the taxies, the control center can help the passenger to find a no-load taxi nearby. However, the taxi monitoring and management system is mainly used for its function of monitoring and management of the taxi operators, and its function for the on-demand service is rarely used in reality. This is mainly because of the number of taxies is relatively fixed for a region. In rush hours, few taxi is no-load and as taxi drivers are easy to find passengers, they are reluctant to respond to a on-demand passenger. In non rush hours, a lot of taxies around are no-load and the passengers thus do not need to use the on-demand service. As a result, the on-demand service basically does not play a role. So overall, the service relationship between taxies and passengers is established on an essentially unpredictable basis. Both the service provider and recipient to a certain degree need to rely on experience and luck. Naturally, such transit system is difficult to achieve high efficiency and high customer satisfaction.

In summary, the existing public transportation system (including bus and taxi) can not provide high quality services and high flexibility to adapt to the needs of the passengers, and has serious defects. Due to these defects, it seems that a city can never be able to keep up building a transit system to meet public's ever changing demand. Additionally, the city's road can neither accommodate too large a transit system.

### SUMMARY OF THE INVENTIONS

One object of the present invention is to provide a passenger behavior oriented smart urban public transport system, which centers on fast response to changes in the passenger demand, dynamically scheduling routes for every vehicle in the system to meet passengers' demand timely and accurately.

This object of the present invention is realized with the following technical solution: a passenger behavior-oriented smart urban public transport system, characterized in that it includes a field system mounted on the passenger vehicle and a control center controlling the field system on the vehicle, wherein the control center and the field system communicate with each other in a wireless manner, the control center is for receiving passengers' input of travel requests, generating corresponding routes and sending the route instructions to the field system mounted on passenger vehicles, which will then travel according to the route instructions received, and the control center will also feedback to the passengers about their respective route arrangements.

The control center includes a scheduling server, a web application server, a geographic information server, a route management server and a passenger itinerary management server. The web application server and geographic information server are connected to receive the passenger's travel request with the start and end locations of the intended ride. The request is forwarded by the web application server to the geographic information server, which can read the city's geographic information data and conduct a search information about the start and end locations of the request. The search result is then transmitted to the route management server, which is connected to the geographic information server. Upon receiving the search result from the geographic information server, the route management will select some existing routes according to the search result and return the selected routes back to the geographic information server, which then screens the selected routes for one that is most optimal and performs recalculation to modify the selected route to form a new route, which is then transmitted to the scheduling server. The scheduling server is connected to the web application server, the geographic information server, the route management server and the passenger itinerary management server. Upon receiving the new route, the scheduling server will upload the information of the new route (including the locations and estimated times for getting on and off for the specific passenger) to the web application server so that the passenger can decide whether or not to take this particular route arrangement and send the decision back to the scheduling server. Upon confirmation by the passenger, the scheduling server finalizes the new route schedule and notifies the route management server and passenger itinerary management server. The passenger vehicle (such as a bus), via the field system mounted thereon, will receive the new route from the route management server and travel according to the new route schedule and, as it travels, send its position information to the route management server. The information of the new route will also be sent to the passenger by the passenger itinerary management server.

The urban intelligent public transport system of the present invention centers on passengers' travel requests, which are transmitted to the control center through the Internet, or wireless Internet (such as mobile phones). The control center can analyze each passenger request and dynamically schedule every vehicle in the system. The vehicles are connected via a wireless network to the control center and are not running along a predefined fixed route. The overall operation of the vehicles in the system can be flexibly adjusted to dynamically meet the passenger demand in a timely and accurate manner. The scheduling and dispatching operation of the control center is fully automatic, without human intervention.

According to the present invention, each vehicle within the transport system has a unique ID number which remains the same and fixed, but the vehicle's travel route is not fixed. When a passenger receives the vehicle's ID number via SMS, he or she knows exactly which vehicle to get on. Each stop in the system is also assigned with a unique ID number. The system of the present invention can make use of the bus stops available in the exiting transport system and may also add independently new stops. Because new stops can be easily added, needing just a unique ID number, more stops can be established in the parts of the city with a dense mobile population so that passengers can get on and off at nearby stops and save the time by reducing the walking distance.

All the vehicles in the public transport system of the present invention are connected to the control center through a communication network, thus achieving interconnection and inter-transmission of information. This system, with no static bus lines, produces real-time dynamic bus lines based on the actual dynamic demand of the passengers. Based on the information collected, the control center can automatically and dynamically schedule the route for each vehicle, which can take passengers with different destinations and individualize getting-on and getting-off locations for each passenger. With the control center, each vehicle knows where is a passenger who needs to take the bus and whether it is suitable to pick up the passenger, and at the same time each passenger knows which vehicle, location and time is his or her best choice. In short, each vehicle's route is determined based on the requests of passengers nearby its current travel route, the destinations of the passengers already on board, the positions of other vehicles of the system, and the current traffic conditions and other factors. In this way, although the bus routes are not fixed, they are indeed completely managed. Thus, the service of public transport is provided just like water and electricity, where when there is a passenger request, the service will be provided in a short period of time. The entire system is flexible with its capacity getting the maximum use.

In the present invention, the field system includes the vehicle, the host computer, the monitor and the positioning module. The host is connected to the control center for receiving route instructions, which are displayed on the monitor so that the driver can observe. The positioning module, being connected to the host, keeps tracking the vehicle's current location and transmitting the location coordinates to the control center via the host.

The second object of the present invention is to provide a method of implementing a smart passenger behavior oriented urban public transport system. This object is realized through a technical solution which includes the following steps:

Step 1: the passenger, wishing to travel from starting point S to ending point T, enters a URL at an inquiry terminal to access the control center's the web application server and inputs into the web application server the inquires about S and T.

Step 2: upon receiving the inquiry request, the web application server forwards it to the geographic information server.

Step 3: the geographic information server conducts a search on a geographic information database for the two locations S and T, and sends the two locations' coordinates to the route management server.

Step 4: the route management server, after receiving the position coordinates, conducts a search on all present routes of the system and retrieves the relevant ones to send back to the geographic information server.

Step 5: the geographic information server then conducts a screening of the relevant routes for an optimal route R and further adjusts R according to the passenger's needs to produce a new route R′, which is then sent to the scheduling server.

Step 6: the scheduling server returns route R′ to the web application server. The route R′ includes the information about the stops and estimated times for the passenger to get on and get off the vehicle, respectively.

Step 7: the web application server transmits the route information via the Internet back to the query terminal and displays it on its user interface for the passenger to confirm.

Step 8: after the passenger confirms the route, the confirmation will be received by the web application server.

Step 9: the web application server then notifies the scheduling server that the passenger has confirmed the ride.

Step 10: the scheduling server then notifies the route management server, confirming that route R has changed to R′.

Step 11: the scheduling server also sends the confirmed route to the passenger itinerary management server, which in turn sends the confirmed route to the passenger.

Step 12: the positioning module of the field system tracks the position of the moving vehicle and uploads the vehicle's current position coordinates to the route management server via the host.

Step 13: the route management server receives the position coordinates of the vehicle and then, according to the specifics of route R′, notifies the field system its next stop and the estimated arrival time, which information is shown on the monitor of the field system so that the driver will drive the vehicle to the next designated stop.

Step 14: when the passenger reaches the destination, the route management server notifies the passenger itinerary management server that the passenger's trip is over and it should close the passenger's itinerary, and the passenger itinerary management server then closes the itinerary immediately and automatically stores it.

Step 15: after completing the entire route, the field system's monitor shows a message from the route management server, prompting the driver to confirm reaching the final stop and close the route.

Step 16: once receiving the driver's confirmation, the route management server closes the route and saves it to the database.

Compared with the prior art, the present invention has the following advantageous effects:

1. The present invention provides an entirely new type automatically managed urban public transport system. The system centers on fast response to passenger travel request. Before the ride, the passenger will submit a request to the control center, via Internet, wireless Internet (such as mobile phones), call center, etc, and then the control center schedules a reasonable bus route to pick up the passenger at a suitable bus stop.

2. Each bus in the system of the present invention does not have any fixed routes and all buses' current routes are dynamically determined on the basis of the trip requests submitted by passengers and the current positions of other buses within the system, and the routes are released by the control center in real-time.

3. Each bus in the system of the present invention is connected to the control center through a wireless communication network, such as GPRS. Each bus' next stop is neither decided by the driver nor by the passengers on board, but dynamically and automatically determined by the control center, which is displayed on the monitor of the field system so that the driver can access the information in advance.

4. Each bus in the system of the present invention can have passengers with different destinations, as the control center's computer servers know exactly each passenger's desired locations for getting on and off, and know exactly how many passengers are to get on and off at each location. At the same time, the system can flexibly control the number of passengers on board of each bus so that it may reach the preset carrying load and have an optimal driving route.

5. Each passenger will receive an advanced SMS message, prompting him or her to get ready before getting on and getting off the bus.

6. Each bus has a unique ID number within the system of the present invention, but the number does not refer to an fixed route. Each bus stop in the system also has a unique ID number. In addition to using the existing bus stops in the city, new stops can be independently added. Because adding a new stop is very simple, just a matter of providing a unique ID number, the bus stops can be established very densely.

7. The authorized staff at the control center of the present invention can, through the monitoring and management workstation, perform manual settings of the scheduling system. Manual settings can affect the scheduling server's scheduling arrangements. Under unexpected urgent circumstances, manual setting may be employed to realize intelligent automatic batch scheduling for part or entire system's buses.

In conjunction with the drawings, specific embodiments of the present invention will be described in further detail in the following.

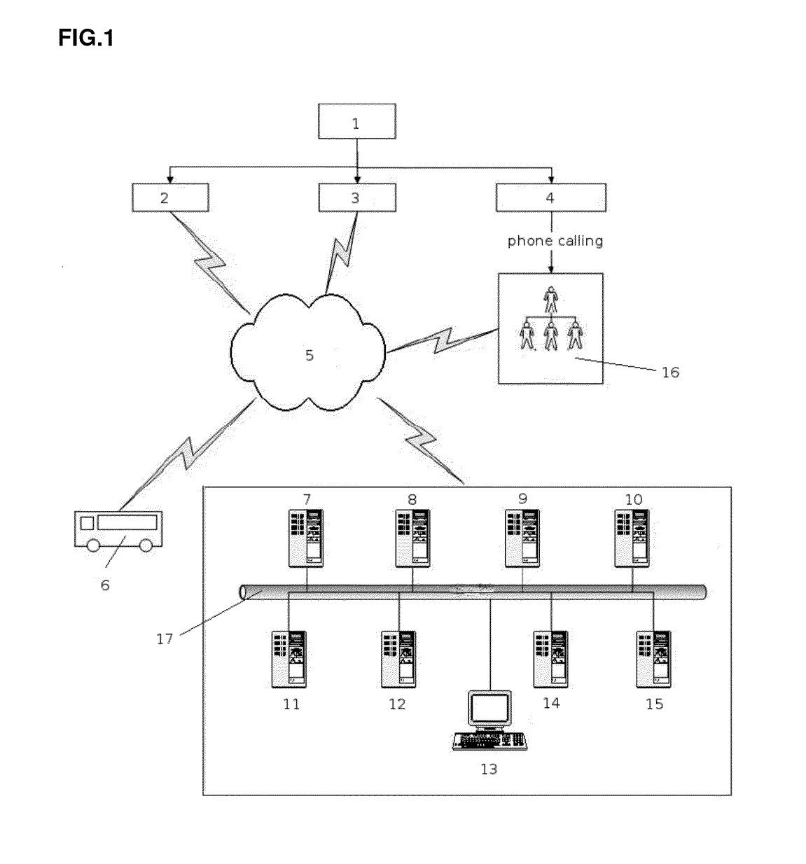

FIG. 1 is a schematic diagram of the overall structure of the intelligent urban public transport system of the present invention.

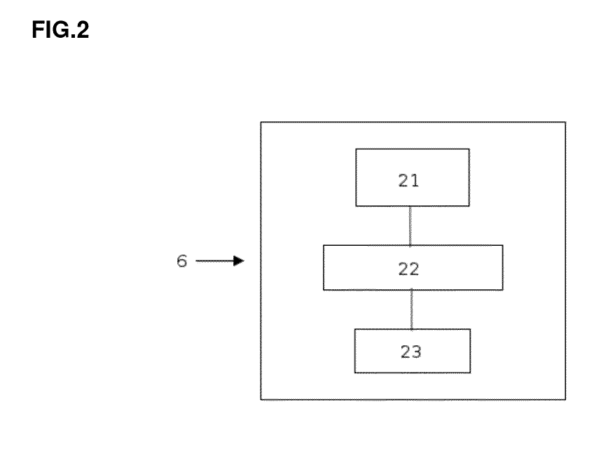

FIG. 2 is a block diagram of the field system according to the present invention.

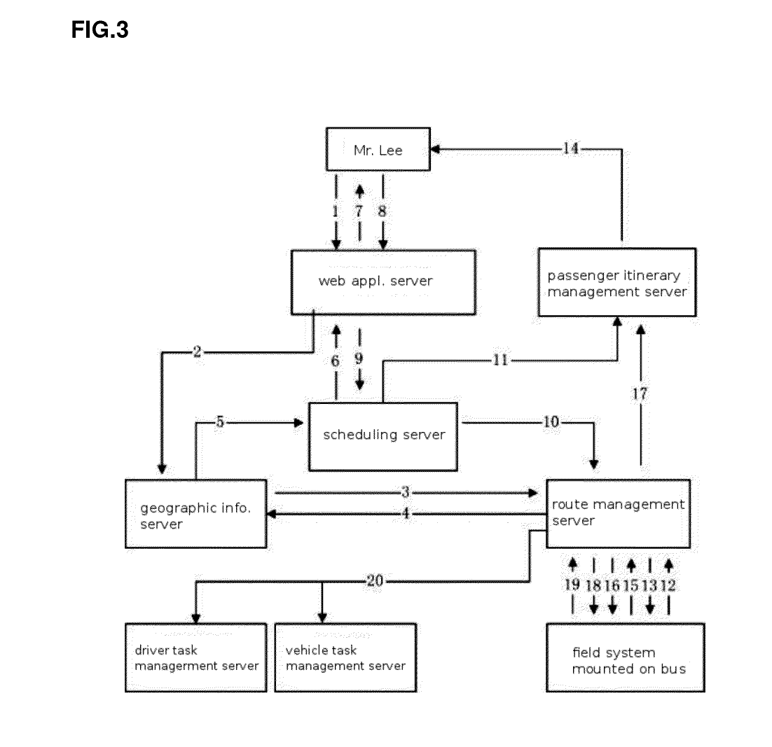

FIG. 3 is a schematic diagram showing the implementation of the intelligent urban public transport system of the present invention.

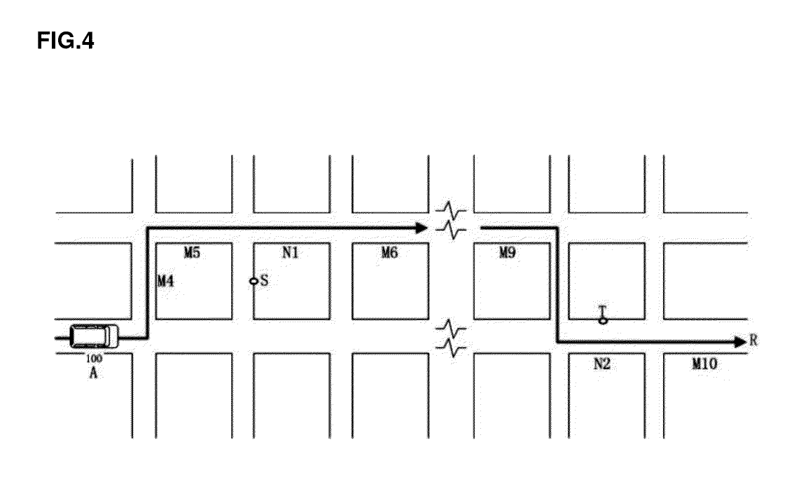

FIG. 4 shows an exemplary route for a bus in the intelligent urban public transport system of the present invention.

### DETAILED DESCRIPTION OF PARTICULAR EMBODIMENTS OF THE INVENTION

Shown in FIGS. 1 to 4, a passenger behavior oriented smart urban public transportation system is disclosed as an embodiment of the present invention, which includes a field system 6 and a control center 18 controlling the field system. The field system is connected to the control center by a wireless communication means. The control center is for receiving requests from passengers for a ride, generating a route and communicating the route to the field system. The vehicle of the field system will travel along the route received from the control center. As the vehicle moves towards the passenger, the control center also send the route information as the feedback to the passenger who submitted the request.

The control center includes a scheduling server 12, a web application server 11, a geographic information server 14, a route management server 7 and a passenger itinerary management server 8. The web application server is connected to the geographic information server, receiving the request from a passenger 1 who specifies the start and end of the desired ride on a query terminal and transmitting the request to the geographic information server. The geographic information server reads the city's geographic information data and, in accordance with the passenger's request, conducts a search for the relevant locations and transmits the search result to the route management server, which is connected to the geographic information server. Upon receiving the search result, the route management server selects potential routes according to the result and sends the potential routes back to the geographic information server, which then screens the potential routes for an optimal one and further modifies the optimal route based on a recalculation, resulting in a new route to be sent to the scheduling server. The scheduling server is connected to the web application server, the geographic information server, the route management server and the passenger itinerary management server. Upon receiving the new route, the scheduling server extracts from it the information relevant to the passenger (i.e., the locations and times for picking up and getting off) who submitted the request, and transmits such information to the passenger via the web server for confirmation. Upon the passenger's confirmation of the ride, the scheduling server will finalize the new route and notify the route management server and passengers itinerary management server. The field system will receive the finalized route from the route management server and the vehicle will travel according the route received. While progressing towards the passenger, the field system will upload the vehicle's real-time position coordinates to the route management server. At the same time, the passenger itinerary management server sends the finalized route to the passenger.

In this embodiment, the query terminal refers to a website user interface accessed by the passenger through an Internet-connected computer 2, mobile phone 3, etc, where the passenger may register, query optimal routes, and make a request for a ride. Alternatively, the passenger may call a call-center 16 by a mobile phone or land phone 4, asking the call-center to query and make a request or reservation. The call-center will then forward the information of the reserved route to the passenger via SMS.

As shown in FIG. 2, in this exemplary embodiment, the field system 6 comprises a bus, a host computer 22, a monitor 21 and a positioning module 23. The host is connected to the control center for receiving commands and instructions of a route from the control center, and delivers such instructions to the driver via the monitor screen. The positioning module, being connected with the host, is for tracking position of the bus in real-time and transmitting the position coordinates to the control center via the host. The host can perform GPS positioning and GPRS data transmission, and is equipped with a speaker. The monitor is used to display the commands and instructions from the control center. The field system has an upload function: every two seconds, it sends via GPRS the current position coordinates of the bus to the route management server at the control center so that the control center knows actual position of every bus in the system. The field system also has a download function: when a bus makes a stop to allow passengers to get on and get off, the field system will generally receive the information about the next stop from the route management server and show the next stop's location and estimated arrival time on the monitor. In addition, if the scheduling server, based on a changed passenger requested and a recalculation, decides to change the next stop for a bus already en route, it will notify the route management server, which will then generate the new information about the bus' next stop and estimated arrival time and transmit the new information to the field system. When the field system receives the new information about the changed next stop, it will show the new updated information about the next stop on the monitor and at the same time will sound the speaker to prompt the driver to observe the new instructions for the next stop. The sound will stop automatically after 10 seconds.

Communication networks: the communication network between the query terminal and the control center can be wired or wireless via the Internet 5, and the connection between the control center and the field system is a wireless communication network, which can be a GPRS data service network, WCDMA 3G wireless network, or 4G wireless network.

In this embodiment, the control center centers around the scheduling server and its job is to analyze the reservation requests of the passengers, to communicate and coordinate with other servers in order to obtain necessary information, and to automatically perform scheduling in response to the request of the passengers. It includes a web application server, a passenger itinerary management server, a route management server, a driver task management server 9, a vehicle task management server 10, a geographic information server, a database server 15 and a monitor and management workstation 13. The control center also establish databases, including a database of bus stops, passengers database, buses database driver database, route history database and geographic information database.

The control center is the core of the entire transport system, and the scheduling server plays the role of coordinating other servers in order to perform the function of automatic vehicle scheduling. All the stops and estimated arrival times for every vehicle in the system are all finalized by the scheduler server. Control center uses a LAN 17 to connect all the servers therein. By communicating with the other servers, the scheduling server can keep abreast of the current position and the next stop of all the vehicles in the system. Upon receiving a passenger's travel request, it interacts with the geographic information server to determine which is the most appropriate bus to be dispatched to pick up the passenger, to determine possible new stops as a result of this dispatch and the corresponding estimated arrival time (i.e., the locations and times for the passenger to get on and off), and to re-determine the subsequent stops and possible changes in arrival times and notify such information to other servers as well as to the field system and the mobile phones of the passengers. The authorized staff at the control center can, through the monitoring and management workstation, perform manual settings of the scheduling system. Manual settings can affect the scheduling server's scheduling arrangements. Under unexpected urgent circumstances, manual setting, with assistance from the scheduling server, may be employed to realize intelligent automatic batch scheduling for the buses in part of the system or in the entire system.

The web application server is connected to the Internet, and runs a www website. Its main function is to respond to the queries from passengers, pass the passengers' travel query requests to the scheduling server, and forward the query results from the scheduling server back to the passenger. The passengers, no matter where they are, as long as having access to the Internet with a computer, a mobile phone, etc, can visit the website, submit the travel request, and get instructions for getting a ride. Passengers can also use a landline or mobile phone to call a call-center 16, which is connected to the Internet. The staff at the call-center can use the computer connected the Internet to access the website on behalf of the passengers to make inquiries and reservations. The web application server is connected to a passenger database so that passengers are able to fill in their phone numbers and other information via the website, and can also personalize the webpage settings. The information and settings will be saved to the passenger database.

The geographic information server can access the city's geographic information database and perform the topology calculation. Its main functions are:

1. It conducts search and confirms whether a named place or building exists and, if exist, obtain its coordinates. For example, when a passenger enters the departure and destination places on the web page of the web application server, the geographic information server can determine whether the named places of departure and destination exist and, if exit, their coordinates.

2. With the coordinates, it can determine which road is close to the coordinates as well as with the traveling distance between the place defined by the coordinates and a certain position. For example, when receiving the real-time coordinates of a bus from the field system, the geographic information server can determine which is the road on which the bus is traveling and the estimated arrival time at each of the subsequent stops.

3. Once knowing a passenger's departure and destination locations, the geographic information server can perform topology calculation based on existing available routes and passenger's request to select an optimal route, which is further adjusted to provide a new route so that the passenger can get on and off the bus at reasonable times and places.

The passenger itinerary management server is to provide the passengers who have confirmed a trip, during the entire ride, the travel guide and reminders. The server is connected to an SMS service center. It maintains the passenger itinerary for each passenger, including information, such as, passenger ID number, passenger phone number, stop ID numbers to get on and off, arrival times, departure location, destination, vehicle ID number, route ID number, etc. The itinerary was originally generated by the scheduling server and then passed to the passenger itinerary management server. During the operation, if the scheduling server makes a route adjustment which changes the getting-on and -off locations and/or times for a given passenger, it will notify the passenger itinerary management server to change the passenger's itinerary. The updated itinerary will then be transmitted to the mobile phone of the passenger via the SMS service. If the conditions on the road or other factors have affected the bus' travel speed and caused changes in the passengers' getting-on and getting-off times (without changing the stop locations), the route management server is responsible for notifying the passenger itinerary management server to change the passenger's itinerary and, if necessary, send the updated itinerary to passenger's mobile phone via the SMS service.

Before the bus is about to arrive at a getting-on or getting-off stop, a prompting message will be timely sent to the passengers via the SMS service. After each passenger completes the ride, his or her itinerary will be automatically recorded and saved by the passenger itinerary management server and at the end of each day (i,e, at the mid-night) all passengers' itineraries will be uploaded to the database server.

The route management server is used to maintain real-time route schedules for every bus in operation within the system. Each route includes the information, such as the bus' current location coordinates, the location coordinates passed, the ID numbers the stops passed, the road section which the bus is currently on, the latest established arrival times at each stops, etc. The routes are originally coming from the scheduling server, and constantly kept up to date. Updating is conducted in two respects. Firstly, the route management server periodically (usually in a two-second interval) receives from the field system each vehicle's positioning coordinates uploaded via the wireless network (which generally refers to a GPRS network), and immediately forwards the received coordinates to the geographic information server, which determines which road section the vehicle is currently on, re-estimates the arrival times for each of its subsequent stops, and then return the information back to the route management server. If the route management server notices any changes in the estimated arrival times, it will update the affected routes and inform the passenger itinerary management server to modify its information of the routes. Secondly, the scheduling server may at any time change the route of a vehicle already en route (i.e., changing the remainder of its route and subsequent stops). These changes will be transmitted to the route management sever which will accordingly update its records of the affected route: the ID number of the subsequent stops, the road section, the location coordinates, and the newly estimated arrival times.

The route management server, in addition to receiving location coordinates from the field system, also decides the next stop and estimates the corresponding arrival time for each of the buses in the system. In general, when a bus arrives at a stop, the route management server will send a command and information about the next stop to the field system. The command and information will be shown on the monitor so that the driver will follow the command and drives the bus to the next designated stop. In another situation, where the route management server may also change a bus' next stop when the bus is already en route to a stop. For example, if the scheduling server, based on passenger requests, decides to change the next stop of a bus already in transit, it will notify the route management server to determine the specifies of the changed next stop and estimates the new arrival time. The route management server will timely send the information of the new stop to the field system's monitor via a GPRS network so that the driver will dive the bus to the newly designated next stop.

After a bus completes a full route, the completed route will be recorded and stored automatically by the route management server. A complete route includes the route ID number, vehicle ID number, driver's name, task ID number, start time, end time, all the location coordinates tracked during the course, duration, as well as the ID number, road location, and arrival time for each stop made. The route management server will upload all the routes of the day to the database server at the mid-night of each day.

The control center also includes a driver task management server and a vehicle task management server. These two servers' job is to timely assign tasks, respectively, to vehicles and drivers that are in an idle state, when the scheduling server requests new vehicles and drivers to enter the service. After a vehicle or a driver enters the work state, the two servers will interfere its subsequent work.

The driver task management server is responsible for managing task distribution among the drivers, including arraigning and issuing task order to the drivers who are in the standby state and keeping track of the drivers who are already assigned with a task. The server maintains in real-time each driver's current location, work status, the route ID number he or she is running and the amount of task completed for the day. When the scheduling server produces a new preliminary route, it will access the driver task management server, making a request to arrange a task at a certain time and certain location. The driver task management server will assign a corresponding driver for the job and return it to the scheduling server for confirmation. Upon confirmation, this new route will be sent to the route management server for starting a real-time tracking. At the same time, the scheduling server notifies the driver task management server to issue the task order to the driver via SMS. It will also set the driver's current state as the work state. The SMS message also includes a task ID number and after boarding the bus, the driver will input the task ID number into the field system on its keyboard and then he or she can start executing the task. When the driver completes the task, the driver task management server will update his or her current state.

The vehicle task manager server is responsible for task distribution and state management for every vehicle in the system, including deployment of the vehicles currently in the standby state and tracking the vehicles in the work state. The server maintains in real-time the current location of every vehicle in the system, its state, the route ID number it is running, and the total travel distance for the day. When the scheduling server produces a new preliminary route, it needs to access the vehicle task management server, making a request to arrange a task at a certain time and certain location. The vehicle task management server will assign a corresponding vehicle for the task and return it to the scheduling server for confirmation. Upon confirmation, the vehicle task management server will set the vehicle's current stats to as the work state. After the vehicle completes the task, the server will update the vehicle's state.

The database server is for hosting a number of the system databases, including a passenger database, a vehicle database, a driver database, a route history database, and a passenger itinerary history database. On the other hand, a geographic information database and a bus stop database are hosted by the geographic information server. The database server's databases are administrated and maintained by the control center's staff via the monitor and management workstation.

The monitor and management workstation has two main functional modules. The first is for monitoring and administering the operation state of the entire system, and the second is for maintaining and generating statistics on the databases.

The function of monitoring and administering the operation state includes presenting every bus' real-time status on a monitoring screen, including the current and subsequent routes, the stops, the load rate, and the driver, as well as the status of the drivers and vehicles that are currently in the idle state: their current locations and the work they already performed for the day.

In case of emergency, the administrator designated by the system may modify the route scheduling made by the scheduling server, realizing human intervention. For example, when a sudden accident happens on a road, the administrator can set that road section as being “closed” via the monitoring and management workstation. The scheduling server will record the setting, and inform the route management server, which will identify the affected routes, alter their original stops at the road section based on a recalculation assisted by the geographic information server, and prompt the driver to bypass the road section by displaying the news and route alteration on the monitor of the field system. In addition, before the road is reopened by the administrator, the scheduling server coordinates with the route management server and geographic information server to avoid the set new stop locations on the closed road. The administrator may also adjust the scheduling server's various operational parameters in order to achieve optimal operational efficiency and similar management adjusts may also be made on the other servers at the control center.

The monitoring and management workstation may also have database maintenance and statistical calculation functions. The control center staff through monitoring and management workstation can access and read the database server's databases, such as passenger database, vehicle database, and driver database. They can carry out day-to-day management of the data in these databases, including maintenance and updating of the basic information. They may also perform the same management tasks on the bus stop database hosted at the geographic information server.

The generation of statistics is based on the data coming from the passenger itinerary server and the route management server, which upload all passenger itineraries and all completed bus routes, respectively, to the database server everyday at a given time. Through the monitoring and management workstation, the administrator may perform various statistic analysis and produce statistic reports on the passengers. The analysis may be on a daily, weekly, monthly, quarterly and annual basis concerning a particular part of (selected according to the actual needs) or the entire passenger population, showing statistical time distribution of the passengers' using transport services and statistical distribution of their departure locations and destinations.

The administrator may perform various statistic analysis and produce statistic reports on the vehicles. The analysis may be on a daily, weekly, monthly, quarterly and annual basis concerning a particular part of (selected according to the actual needs) or the entire vehicle fleet of the system, showing statistical distribution of their operational times, operational duration lengths, roads passed, and stops made.

The administrator may perform various statistic analysis and produce statistical reports on the drivers. The analysis may be on a daily, weekly, monthly, quarterly and annual basis concerning a particular part of (selected according to the actual needs) or the entire staff of drivers, showing statistical distribution of the times of their working hours, the lengths of their working hours, roads they traveled and their punctuality rates.

Now turning to FIGS. 3 and 4, they illustrate a method implementing a passenger behavior-oriented smart urban public transport system according to the present invention by taking passenger Mr. Lee as an example, who wants to travel from S to T. The method comprises the following steps:

Step 1: Mr. Lee hopes to go from S to T and so he uses a quiry terminal, i.e., a PC connected to the Internet, and enters the URL to access the website hosting the web application server of the control center of the system according to the present invention. He logins with his user name (which is assumed to have already been registered to the system) and is presented with a query interface. He then enters his departure location S and destination T, and S and T is then transmitted to the web application server.

Step 2: The web application server receives the query request from Mr. Lee, and forward it to the geographic information server.

Step 3: The geographic information conducts a search on its database for information relevant to the query request, finds the position coordinates of these two locations, and forward these coordinates to the route management server.

Step 4: The route management server receives the position coordinates, and will search and retrieve all relevant routes which are returned to the geographic information server.

Step 5: The geographic information server screens the retrieved routes for an optimal route R, and then preliminarily adjusts the route in view of Mr. Lee's needs to generate a new route R′. The process in which the geographic information server conducts the preliminary adjustment on the route is as follows: in the exemplary situation shown in FIG. 4, a vehicle with an ID No. 100 is currently at in position A, route R satisfies the conditions that it has a number of already established stops M1 . . . Mn, of which it is reasonable to insert a new stop N1 between M5 and M6 and a second new stop N2 between M9 and M10, where both S to N1 and N2 to T are a convenient walking distance. Thus, the geographic Information server preliminarily adjust the route R by adding new stops N1 and N2, which then becomes new route R′. The geographic information server returns route R′ to the scheduling server for initial confirmation.

Step 6: Upon initial confirmation by the scheduling server, route R′ will be turned to the web application server, which includes the information of the stop locations and estimated times for Mr. Lee to get on and off the bus.

Step 7: The web application server forwards the specifics of route R′ as the query result to Mr. Lee's query terminal, that is, his personal computer, and shows the information on the user interface for Mr. Lee to confirm the ride.

Step 8: When Mr. Lee confirms, say, by clicking on a confirmation button on the interface, the web application server will receive a message of his confirmation.

Step 9: The web application server then notifies the scheduling server to inform it that Mr. Lee has confirmed the ride.

Step 10: The scheduling server then notifies the route management server to confirm that the original route R has been changed to R′ and it should execute route R′ instead and the specifics of route R′ will then be transmitted by the route management server to the field system, which will execute route R′ accordingly.

Step 11: The scheduling server will also transmit the new route R′ to the passenger itinerary management server and at the same time generates and sends a passenger itinerary entry to the passenger itinerary management server for maintenance. The passenger itinerary management server then sends relevant trip information to the passenger, Mr. Lee, and is responsible for providing Mr. Lee with guiding information and reminders from now on until completion of his trip. The trip information provided to Mr. Lee includes passenger ID number, passenger mobile phone number, the stop ID numbers for getting on and getting off, the bus ID number and the route ID number.

Step 12: While bus No. 100 is in transit, say, at stop M5, the field system's positioning module on the bus tracks its current position and uploads the position coordinates to the route management server via the host.

Step 13: The route management server, based on the coordinates received, knows that Bus No. 100 has reached Stop M5, and immediately notifies the field system of Bus No. 100 that its next stop is Stop N1 as well as the estimated arrival time. This notification is displayed on the monitor of the field system so that the driver can observe and drive towards Stop N1 accordingly.

Step 14: In about 10 minutes before Bus No. 100 is estimated to reach Stop N1, the passenger itinerary management server sends a SMS to Mr. Lee to tell him that he may set off from location S for Stop N1 and wait for Bus No. 100 there. After Mr. Lee gets on Bus No. 100, in about five minutes before Bus No. 100 reaches Stop N2, the passenger itinerary management server sends a SMS to Mr. Lee and tells him to get ready for dismount. When the Bus arrives at Stop N2, Mr. Lee gets off.

Step 15: After Bus No. 100 arrives at Stop N2, the host of the field system will upload the bus's present location coordinates to the route management server at the control center.

Step 16: The route management server, based on the coordinates received, knows that Bus No. 100 has reached Stop N2, and immediately notifies the field system that its next stop is Stop M10, as specified by route R′, and the estimated arrival time at the stop. This notification is displayed on the monitor of the field system so that the driver can observe and drive towards Stop M10 accordingly.

Step 17: The route management server then informs the passenger itinerary management server that Mr. Lee's ride has completed and his passenger itinerary can be closed. Upon receiving this notice, the passenger itinerary management server closes Mr. Lee's itinerary and automatically saves it to the database.

Step 18: When Bus No. 100 reaches the last stop of the route, it means the completion of the entire route. At this point, the field system's monitor will display a prompt message which asks the driver to confirm that the bus has reached the last stop and the entire route is completed.

Step 19: The driver confirms accordingly by clicking on a confirmation button on the keyboard of the field system, and the route management server will receive the driver's confirmation and close the route and automatically save the route to the database.

Step 20: The route management server then notifies the driver task management server and vehicle task management server, which set the state of the driver and Bus No. 100 as “standby”, respectively.

1. (canceled)

2. (canceled)

3. (canceled)

4. (canceled)

5. A public transport system, comprising a control center and a plurality of field systems which are in connection wirelessly with said control center; said field system comprising a vehicle, a computer host mounted on said vehicle, and a monitor and a positioning module both connected to said computer host; said vehicle carrying a plurality of passengers with different destinations and traveling only along a dynamic route defined and sent to said field system by said control center and not along any static fixed route; said dynamic route defining a plurality of stops for passengers to get up or get off, and being generated based on requests by passengers and subject to changes before or after said vehicle is en route by said control center; said positioning module uploading said vehicle's position coordinates via said computer host to said control center in a predefined interval while said vehicle is en route.

6. The public transport system according to claim 5, wherein said vehicle has a passenger capacity similar to that of a bus and said dynamic route comprises at least 10 stops.

7. The public transport system according to claim 5, wherein said predefined interval is two seconds.

8. The public transport system according to claim 6, wherein one or more new stops are added to said route while said vehicle is already on its way traveling along said route.

9. The public transport system according to claim 5, wherein said control center via a web application server is connected to a website accessible by a passenger from a query terminal to submit a request for a ride.

10. The public transport system according to claim 9, wherein said control center has a geographic information server and a route management server and, after receiving a ride request from a passenger, will propose an itinerary for said passenger to confirm, said itinerary being generated by interactions between said route management server and said geographic information server of said control center.

11. The public transport system according to claim 10, wherein said control center has a passenger itinerary management server and, after said passenger confirms said proposed itinerary, said passenger itinerary management server will send said itinerary to said passenger via a SMS service.

12. A method of creating and operating a public transport system, comprising steps of: (a) providing a control center and a plurality of field systems; (b) providing a wireless means of connecting said control center and each of said field systems; (c) providing a website connected to said control center to allow a passenger to submit a quest for a ride on a vehicle of said transport system; (d) creating a new route by said control center from scratch or from modifying an existing route, which provides said passenger with two stops close to said passenger's departure and destination sites; (e) providing a means for said passenger to confirm a ride with said new route; (d) transmitting said new route confirmed by said passenger from said control center to a filed system to cause a vehicle travel along said new route to pick up said passenger.

13. The method according to claim 12, further comprising a step of sending a SMS message informing said passenger with an itinerary specifying stops and times for said passenger to get on and get off a vehicle, respectively, after said ride being confirmed by said passenger in step (e).

14. The method according to claim 12, wherein said control center has a route management server and a geographic information server for creating dynamic routes for all passenger vehicles in said system.

15. The method according to claim 14, wherein said field system comprises a passenger vehicle, a computer host, and a positioning module and is responsible to receive a dynamic route while said vehicle is en route, and to upload said vehicle's position coordinates to said control center in a predefined interval.
